(19) United States
(12) Patent Application Publication
(10) Pub. No.: US 2018/0133916 A1
(43) Pub. Date: May 17, 2018

(54) HAND TOOL FOR CUTTING AND SERVING PORTIONS OF CULINARY PREPARATIONS

(71) Applicant: TELLIER GOBEL ET CIE, Argenteuil (FR)

(72) Inventor: Sébastien ROUVILLE, Paris (FR)

(21) Appl. No.: 15/564,426

(22) PCT Filed: Apr. 12, 2016
(86) PCT No.: PCT/FR2016/050838

§ 371 Date: Oct. 4, 2017

(30) Foreign Application Priority Data
Apr. 13, 2015 (FR) 1553194

(51) Int. Cl. B26D 3/24; A47G 21/04

(52) U.S. Cl. CPC B26D 3/245; B26B 9/02; A47G 21/045

(57) ABSTRACT

A hand tool to cut and serve slices of a substantially flat food preparation with a curved perimeter edge, particularly a circular one (cake, quiche, tart, pizza). The hand tool includes a handle and a flat active part with a triangular shape with two sides having a common point opposite the handle and defining a pointed angular sector facing the third side of the triangle next to the handle. The active part includes radial segments configured to geometrically determine a given number of equal slices. The active part includes, on one of the lateral sides of the triangle, radial segments offset relative to each other and coplanar with the general plane of the active surface. Each segment is set at a distinct angle in relation to the median longitudinal axis of the hand tool running through the point of the triangle connecting the two lateral sides and through the handle.

This invention relates to a hand tool designed firstly for cutting food products placed on a baking or serving dish, such as a mold, and secondly for serving the cut slices one by one.

Particularly, this invention relates to a hand tool that is usually called a “cake slice” in a simplified manner.

Such a tool is designed for cutting and serving slices of a relatively flat food preparation with a curved perimeter edge, particularly a circular one, such as a cake, tart, pizza, quiche or the like, placed in a dish or a mold or on a support, for baking or presenting said preparation.

The difficulty of cutting equal slices in a substantially flat food preparation with a curved edge, particularly a circular one, where each slice is made up of a given angular sector of the food preparation is known.

The visual and empirical determination of a number of even parts is not very difficult, by determining the center of the preparation and dividing it successively in halves if needed. The preparation is divided into halves along a diameter, then each half is halved in its turn until the required slice is obtained.

That is not the case with an odd number of slices, the less so with numbers above five or even above three. One just has to imagine the difficulty in making nine equal slices out of a round tart.

Whether in the home or in a business, it is important for a user to be able to cut equal slices or at least slices that show extremely small differences that are not noticeable by the consumer.

The difficult is even greater when in reality the operation is made up of three stages, namely the determination of slices, the cutting of each slice and lastly the lifting or separation of each of them to serve them to the consumers.

Hand tools are in existence that are designed to carry out the two operations, of cutting and lifting each of the slices. These known tools form a kind of spade, comprising a handle that can be grasped by the hand of the user, and an active flat part that is triangular in shape, wherein one side of said triangle is designed in a manner as to slice the food preparation.

It remains that these known tools of the cake slice type need to be associated with one or more other elements for determining equal slices.

That has drawbacks.

First of all, the user must have two or more distinct elements or devices, which can be inconvenient in terms of organization and storage.

Further, the fact that two or even more successive operations are required makes the user's task more complicated, with the corollary of a lack of conviviality vis-à-vis the consumers present.

Lastly, another difficulty is related to the user's concern to minimize the handling of the preparation to consume, and the interaction of tools affecting its integrity.

This invention aims to remedy those difficulties, and discloses a single tool which allows, in addition to the determination of a given number of equal slices, the cutting of each slice and the separation/lifting of the slices from the dish on which the preparation is placed, so as to serve each slice.

The invention will be particularly described by reference to a hand tool of the cake slice type, for flat food preparations with a curved perimeter edge, particularly one circular in shape, such as cakes, tarts, quiches or the like, placed on a dish, in a baking mold or a flat support.

To that end, according to the invention, the hand tool designed for cutting and serving slices of a substantially flat food preparation with a curved perimeter edge, particularly a circular one, such as a cake, quiche, tart, pizza or the like, of the type comprising a handle likely to be grasped by the user's hand and a flat active part with a triangular shape wherein two sides, known as the lateral sides (with a common point opposite the handle) with a radial direction define a pointed angular sector facing the third side of the triangle next to the handle, is characterized in that the active part comprises means adapted to enable the user to geometrically determine a given number of equal slices.

A “radial” element is an element:
with a direction transversal to the longitudinal direction of the tool and/or:
which, in the position of use of the cake slice, extends radially in relation to the circular food preparation.

Thus, with only one tool, the user can carry out the three operations, namely determine the ad hoc angular section, cut and separate/lift each slice, where the slices are strictly equal, further without affecting the food preparation excessively.

According to one characteristic, the active part comprises, on one of the lateral sides of said triangle, a series of segments known as radial segments, which are offset or protrude in relation to one another (and are at the same time coplanar with the general plane of the active surface), where each is set at a distinct angle in relation to the median longitudinal axis of the spade running firstly through the point of the triangle connecting the two sides, and secondly through the handle.

More precisely, the active part comprises, on one of the radial sides of said triangle, a series of radial segments, where each is directed so as to define a radial direction, which firstly runs through the tip, and secondly forms with the other radial side of the triangle an angular sector the angle of which is equal to 360°/n, where “n” is an integer.

Said number “n” ranges between 3 and 25, preferably between 5 and 11.

Advantageously, the side with the radial segments is not straight but is discontinuous, and the radial segments form a plurality of offsets in relation to one another. Each radial segment is separated from the next one by a linear offset that is substantially transverse, preferably forming an angle of about 120° with the neighboring radial segment. Each offset links the distal end of a radial segment to the starting end of the next radial segment.

The radial segments increase in length respectively, starting from the tip.

In an exemplary embodiment, the length of the side opposite the sides with radial segments is approximately 125 mm and the tool has five radial segments, where the length of each of these is respectively as follows, starting from that near the tip: 16 mm; 14 mm; 17 mm; 20 mm and 30 mm.

The spade particularly has the following dimensions in a preferred example:
lateral sides of the triangle: 125 mm
third side of the triangle (opposite the tip): 70 mm

Preferably, the lateral side of the triangle opposite that with radial segments is designed so as to make it possible to cut through the food preparation.

The handle has an elongated shape, and its direction runs through said tip.

Preferably, the handle is in a plane substantially parallel to that of the active triangular part and is offset in the transverse direction.

This invention will now be described with the help of examples that merely illustrate the scope of the invention, but are not limitative in any way, and by reference to the accompanying drawing, wherein:

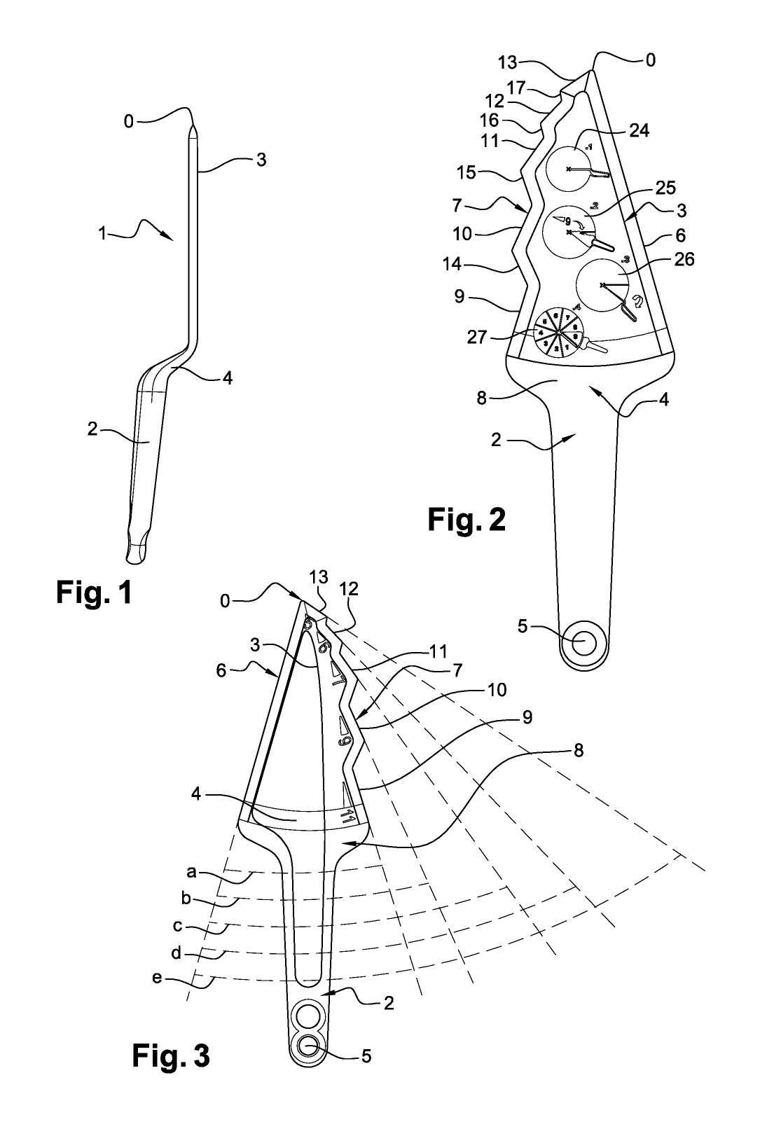

FIG. 1 is a side view of the tool according to the invention.

FIG. 2 shows the side known as the lower side of the tool, in a plan view, where the method of use is advantageously shown in schematic form on that side for the user.

FIG. 3 shows the side known as the upper side of the tool, in a plan view, so as to show the angular sectors demarcated by the radial segments.

FIGS. 4, 5A, 6 and 7 are schematic top views of a round tart and the tool in the different stages of use.

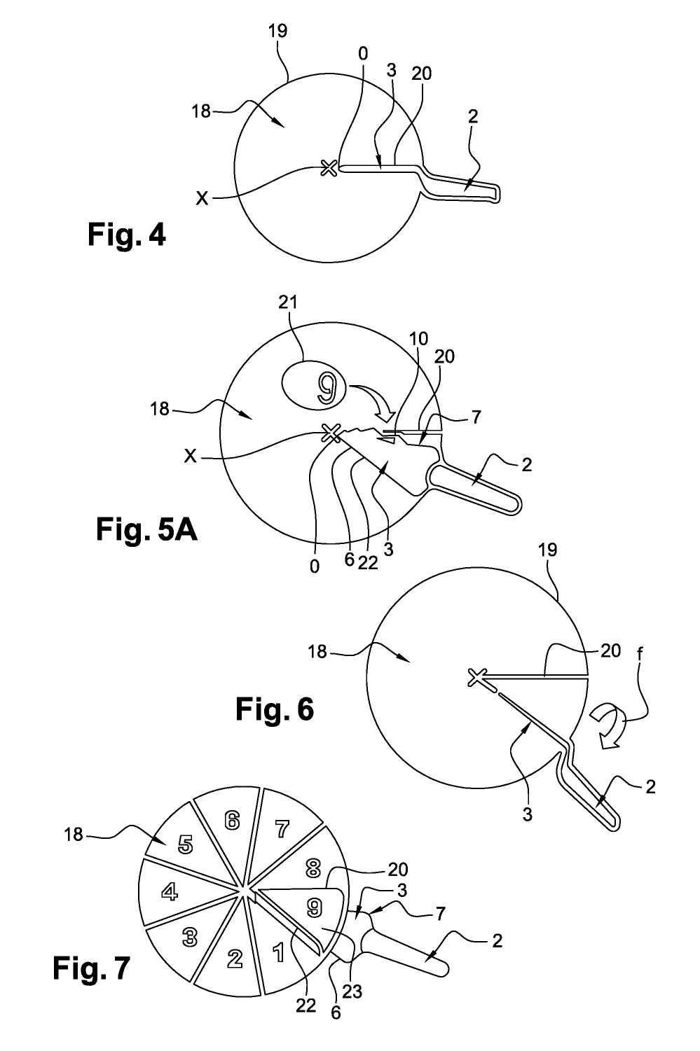

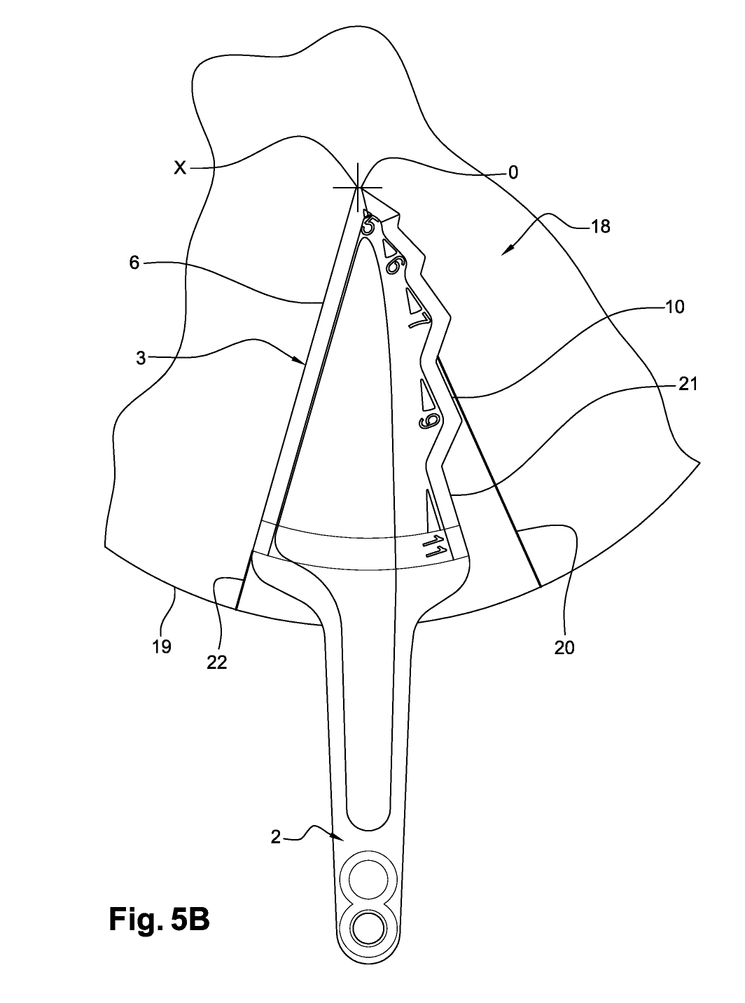

FIG. 5B is an enlarged view of FIG. 5A.

In the description below, the terms “length” and “depth” and the describers “horizontal”, “vertical”, “upper”, “lower” “high” and “low” of an element are used as part of the normal use of the tool, that is to say relative to a vertical in relation to a horizontal plane, and in relation with a user grasping the tool.

The terms “radial”, “transversal” and “longitudinal” refer to the overall longitudinal direction of the tool. The terms “distal” and “proximal” refer to the position of an element in relation to the user.

The description now refers to FIG. 1 showing a side view of the tool according to the invention 1 comprising a handle 2 with a section that is substantially circular or elliptical, and a flattened active part 3 that is triangular in shape (FIGS. 2 and 3) and forms a “spade”. The handle 2 and the spade 3 are joined by an intermediate part 4.

The longitudinal axis of the handle 2 and the plane of the spade 3 are parallel and vertically offset, and the intermediate part 4, which extends in a plane that is substantially perpendicular to the planes of the spade and the handle, forms a sort of “S” when seen from the side.

The distal end (opposite the handle 2) of the spade 3 is referenced by the letter “O”.

In FIG. 3, the tool is shown in a plan view of its upper side, facing the user, on which the slice is supported and thus lifted to be served.

In FIG. 2, the tool is shown in a plan view of its lower side, opposite the user, which side rests on the support or dish on which the food preparation (cake, tart, pizza, quiche etc.) is placed before it is served.

At the proximal end (close to the user) of the handle 2, there is a hole 5 for hanging the tool.

In the top view (FIGS. 2 and 3), the spade 3 forms a triangle, isosceles in this case, with its point at the distal end O of the spade, comprising two sides 6 and 7 extending from the point O and forming the lateral edges of the spade, and a transverse base 8, common to the intermediate part 4.

One of the edges, edge 6 (or side of said triangle) is straight, and is tapered or sharpened for slicing the food preparation.

The other edge 7 (or other side of said triangle) has cuts that are generally shaped like the teeth of a saw, including:
Five radial segments 9, 10, 11, 12 and 13 turned along a straight line running through the tip O, each forming with the other straight edge 6 a respective given angle (a, b, c, d, e);
Four straight offsets 14, 15, 16 and 17 in a direction that is slanted in relation to the radial segments and directed substantially parallel or forming an angle below 30°, with the opposite edge 6 of the spade 3.

In general, the angles with references from “a” to “e” and the following angles, if there are more radial segments and offsets, are such that the angle “a” is the smallest angle between the straight edge 6 and the radial segment closest to edge 6, here radial segment 9, which corresponds to the smallest dimension of equal slices to be cut in the food preparation. The angle “e” is the largest dimension of equal slices to cut in the preparation and separates the straight edge 6 from the furthest radial segment and close to the point O, namely segment 13.

Starting from “a”, the angles from “a” to “e” are equal to 360°/n, where “n” is the number of equal slices to cut.

In the example shown, the angles with references from “a” to “e” have values of 33°, 40°, 52°, 60° and 72° respectively.

In the illustrated example, the number of equal slices that can be cut is: 11, 9, 7, 6, or 5.

The radial segments and offsets are placed alternately. Thus, the edge 7 comprises the following, starting from the handle 2: the first radial segment 9, the first offset 14, the second radial segment 10, the second offset 15, the third radial segment 11, the third offset 16, the fourth radial segment 12, the fourth offset 17, the fifth radial segment 13.

The distal end of the fifth radial segment 13 forms the distal end O of the tool.

Each pair made up of a radial segment and an offset forms a sort of triangular tooth.

The angle formed by a radial segment and the successive offset is the same for each radial segment/offset pair, and is about 120°.

By reference to FIG. 3, near each radial segment, corresponding marking is provided, with a number, in this case successively 5, 6, 7, 9 and 11 respectively, starting from the tip O.

Similarly, by reference to FIG. 2, the lower side of the spade has drawings, pictograms or the like, the role and meaning of which are described later.

The tool is preferably made from food grade plastic, preferably thermoplastic material such as polypropylene, polycarbonate, polyamide, polystyrene, copolyester, polyethylene and generally any type of rigid plastic. Thermosetting material such as melamine may also be used, as may elastomers (with a high Shore index) such as silicone or polyurethane. Manufacturing is preferably carried out by injection, or alternatively using the compression molding technique.

The benefit of such material is that it does not scratch baking molds, dishes and pans, which are generally coated with non-sticking material that is relatively fragile.

In a preferable embodiment, the tool comprises a core or body that forms a single block of rigid plastic such as polypropylene and over molding in polypropylene, in a different color. It may also be made of a single block on which colored raised markings or varied surface finishes are applied.

The tool may alternatively be made in stainless steel, aluminum, wood, carbon or any type of rigid material.

The working and use of the tool are described below by reference to FIGS. 4 to 7.

FIG. 4 contains a very schematic illustration of the top view of a food preparation 18, such as a tart, quiche or the like with a circular perimeter edge 19.

The center of the tart 18 is marked “X” for greater clarity.

In order to make the illustration easier to understand, the tart 18 is represented only by a circle 19 corresponding to the perimeter edge of the tart. The tool is represented schematically and grayed.

At the start, the user grasps the tool in the hand, using handle 2, and puts it on the tart 18 so that:
the distal end O of the tool is placed on the center X of the tart;
the cutting edge 6, opposite the edge 7 which comprises the radial segments and offsets, is applied to the top of the tart;
the plane of the spade 3 is substantially orthogonal to the plane of the tart 18.

Lastly, the user cuts the tart along a cutting radius 20 using the cutting edge 6.

By reference to FIG. 5A, in a subsequent stage, the user continues to hold the tool and moves it so that:
the distal end O of the tool is at the center X of the tart;
the spade 3 is parallel to the plane of the tart and very close to it or resting on it;
one of the radial segments, here the second radial segment 10, corresponding to the marking 21 (number 9) on the upper side of the spade 3, coincides with the radial cut 20 formed in the tart 18 during the previous operation.

FIG. 5B is a detailed view at a larger scale of the tart 18 and the tool in FIG. 5A.

The number 9 of the marking 21 (opposite the radial segment 10) corresponds to the number of equal slices that the user needs to cut in the example of FIGS. 4 to 7, 9 slices in this case.

In the position of FIGS. 5A and 5B, it can be seen that the cutting edge 6 is directed along a radius 22 on the tart 18.

In the following stage, in FIG. 6, the user turns the tool as shown by the arrow “f” so that the cutting edge 6 of the spade is applied to the tart 18, particularly along the radius 22 (FIGS. 5A and 5B).

The user then applies pressure to the tool in a direction orthogonal to the tart 18, thus usually along a downward vertical direction, so that the edge 6 cuts the tart 18 along the radius 22. The user then repeats the tart cutting operation from the radius 22 (as they had done from the radius 20) and so on until the required number of slices has been cut.

By reference to FIG. 7, after the cut along the radius 22 is made, the user lifts the tool to slide the spade 3 under the slice 23 cut in this way, symbolically bearing the number 9 to identify the number of equal slices into which the tart 18 is to be cut.

Also for more clarity and in a symbolic manner, FIG. 7 shows the nine slices cut in this way, each bearing a number from 1 to 9 to identify each slice, which are cut one after another in the same way as described above, by reference to FIGS. 4, 5A, 5B and 6.

Thus, the tool according to the invention is used to determine equal slices and cut them and lastly to serve the slices one after another, where the slices are strictly equal.

In order to make the tool easier to use, its method of use is represented symbolically by drawings or pictograms on the lower side of the spade, by reference to FIG. 2.

There are four pictograms and drawings, referenced 24, 25, 26 and 27, and which correspond to FIGS. 4, 5A, 6 and 7 respectively.

The invention has been described in an example for cutting 5, 6, 7, 9 or 11 equal slices. Radial segments may be provided that correspond to an even number of slices only (for example 4, 6, 8, 10 slices), or an odd number of slices only (for example 3, 5, 7, 9 and 11 slices). Similarly, the maximum number of equal slices that can be cut is limited by the size and dimensions of the tool.

1-10. (canceled)

11. A hand tool configured to cut and serve slices of a substantially flat food preparation with a curved perimeter edge, comprising:
a handle to be grasped by a user's hand;
a flat active part with a triangular shape with two lateral sides having a common tip opposite the handle and defining a pointed angular sector, in a radial direction, facing a third side of the triangle next to the handle;
wherein the active part comprises, on one of the lateral sides of the triangle, a series of radial segments directed so as to define the radial direction, which firstly runs through the common tip, and secondly forms with the other lateral side of the triangle an angular sector, an angle of which is equal to 360°/n, where n is an integer;
wherein the radial segments form a plurality of offsets in relation to one another, each radial segment is separated from a next one by a linear offset that is substantially transverse and links a distal end of said each radial segment to a starting end of the next radial segment; and
wherein the radial segments increase in length respectively, starting from the common tip.

12. The hand tool according to claim 11 configured to cut and serve slices of the food preparation with a circular edge, the food preparation is a cake, quiche, tart or pizza.

13. The hand tool according to claim 11, wherein a range of the number n is between 3 and 25.

14. The hand tool according to claim 11, wherein the range of the number n is between 5 and 11.

15. The hand tool according to claim 11, wherein a length of the lateral side opposite the lateral side with radial segments is 125 mm; wherein a number of the radial segments is five; and wherein a length of each radial segment is respectively as follows, starting from a radial segment near the common tip: 16 mm; 14 mm; 17 mm; 20 mm and 30 mm.

16. The hand tool according to claim 11, wherein the lateral side of the triangle, opposite the lateral side with the radial segments configured to determine a given number of equal slices, is configured to cut through the food preparation.

17. The hand tool according to claim 11, wherein the handle has an elongated shape, and its direction runs through the common tip.

18. The hand tool according to claim 17, wherein the handle is in a plane substantially parallel to that of the flat active part and is offset in a transverse direction.

19. The hand tool according to claim 11 is configured to cut an even or odd number of equal slices in a circular food preparation.

20. The hand tool according to claim 11, wherein the handle has a hole to hang the hand tool.

21. The hand tool according to claim 11, further comprising a marking near each radial segment.

22. The hand tool according to claim 15, further comprising a marking near each radial segment, the markings are successive numbers 5, 6, 7, 9 and 11, respectively, starting from the common tip O.

23. The hand tool according to claim 11, further comprising a lower side, the lower side comprising drawings or pictograms representing symbolically a method of using the hand tool.

24. The hand tool according to claim 11, further comprising a body formed of a single block of a rigid material.

25. The hand tool of claim 24, wherein the rigid material is a plastic, stainless steel, aluminum, wood or carbon.
